(19) United States
(12) Patent Application Publication
(10) Pub. No.: US 2014/0131379 A1
(43) Pub. Date: May 15, 2014

(54) SCALE DISPENSER SYSTEM

(71) Applicant: CONTEK SHILSTONE INC., St-Hubert (CA)

(72) Inventors: Xavier Renaud, St-Mathias (CA); Cyrille Renaud, Mont St-Gregoire (CA)

(73) Assignee: CONTEK SHILSTONE INC., St-Hubert (CA)

(21) Appl. No.: 13/836,542

(22) Filed: Mar. 15, 2013

Related U.S. Application Data
(60) Provisional application No. 61/726,487, filed on Nov. 14, 2012.

(51) Int. Cl. B67D 7/08

(52) U.S. Cl. CPC B67D 7/08
USPC 222/1; 222/23

(57) ABSTRACT

The present document describes a device dispensing portion to be installed on a dispensing fluid tank having an outlet, an inlet and a longitudinal axis which comprises an inlet for receiving a fluid and for being connected to the fluid tank outlet, an outlet for dispensing a fluid, the device dispensing portion defining a longitudinal axis at an angle with the tank longitudinal axis for dispensing fluid substantially free of centripetal swirling action; and a compression single point load cell located at the dispensing portion outlet to dispense fluid at a predetermined amount.

### CROSS-REFERENCE TO RELATED APPLICATIONS

This application claims priority under 35 USC §119(e) of U.S. provisional patent application 61/726,487 filed on Nov. 14, 2012, the specification of which is hereby incorporated by reference.

### BACKGROUND

(a) Field

The subject matter disclosed generally relates to the field of devices and systems for dispensing fluids. More specifically, the present description is directed to a dispensing device including a load cell which allows a precise determination of a fluid amount being dispensed.

(b) Related Prior Art

Mixing and dispensing systems are intended to expel or deliver a fluid, a fluid concentrate, a mixture and the like. Generally, fluid dispensing systems require a mechanism to pump or expel the fluid, a nozzle or interface between the liquid and the external environment and a method or device to control the flow rate of the liquid.

According to U.S. Patent application No. 2009/0236361, typically fluid dispensing systems expel the fluid either by using a diaphragm pump, a peristaltic pump, a direct gas pump, or by using gravity to cause the liquid to flow out of the ingredients storage container. However, this system cannot precisely measure the flow rate of the fluid coming out from the dispenser device.

A diaphragm pump uses a movable diaphragm to directly push the fluid out of the storage container. A disadvantage of this type of prior art pump is that the ingredient being pumped comes in direct contact with internal parts of the diaphragm pump. Such contact increases the risk of bacterial contamination, by example in the case of food industries and biopharmaceutical industries, and makes the system difficult to clean and sanitize.

A peristaltic pump, on the other hand, comprises a rotating apparatus which periodically squeezes a substance through a flexible tube. One disadvantage with using this specific kind of pump is that whenever a new fluid is loaded into the system, the operator must mate the disposable tube to the permanent peristaltic pump tube. Another disadvantage of the peristaltic is that the permanent tubes come in contact with the product and must be washed out regularly to maintain appropriate levels of sanitation, by example in the case of food industries and biopharmaceutical industries.

Another way to expel a fluid from a sealed tank is with a compressed gas system as is done, for example, with a beer keg. In a compressed gas system, a compressed gas is introduced into the fluid container, the pressure of which expels the fluid. A major drawback with this method, however, when applied to edible or organic products, is that the propellant gas coming in direct contact with the product makes the product more prone to spoilage or environmental contamination.

Another direct method of measuring fluid volume is to put measuring devices in-line with product flow. Vacuum, pressure, or conductivity can be sensed in-line to determine when the tank is empty. A major disadvantage of the in-line sensing method is that it requires measuring devices that come in physical contact with the product. This is a potential source of contamination that requires proper cleaning and sanitation precautions in food industry and biopharmaceutical industry by example.

So far, in a gravity flow system, the weight of the fluid is used to provide the force which is needed to expel the fluid.

According to U.S. Pat. No. 7,516,909, a first disadvantage of the actual gravity flow system, however, is that the flow rate of the dispensed fluid is dependent on the head pressure of the fluids. As the fluid empties, the head pressure decreases, which result in a reduction of the flow rate, which makes difficult the control of the mixing and dispensing system. However, this system is not applied for a continuous fluid dispensing device.

A second disadvantage of the gravity of the flow system is that more viscous ingredients, non-newtonian fluids by example, will flow at unacceptably slow flow rates, which also makes hard the control of the mixing and dispensing system.

On the other hand, a direct method of measuring fluid quantity weighs the ingredient container using a load cell or a pressure sensor. The main issue of the actual load cell approach is that measuring inaccuracies may result in multiple manners. Indeed, in fluid dynamics, turbulence or turbulence flow presents a fluid regime characterized by chaotic, stochastic fluid property changes. This includes rapid variation of pressure and velocity in space and time. Because of those fast variations in the flow rate of the fluid, it becomes difficult to obtain very few measuring inaccuracies.

For these disadvantages established in the advanced industrial mixing and dispensing systems, there is therefore a need for dispensing device which can weigh the fluid with extreme accuracy and then accurately determines the mass flow rate of a fluid by avoiding centripetal swirling action, avoiding the plug hole effect and maximizing the dump flow rate.

### SUMMARY

It is an object of the present disclosure to provide a device and a system for dispensing fluids that overcomes or mitigates one or more disadvantages of known such systems or at least provides a useful alternative.

According to an embodiment, there is provided a device dispensing portion to be installed on a dispensing fluid tank having an outlet, an inlet and a longitudinal axis which comprises:
an inlet for receiving a fluid and for being connected to the fluid tank outlet;
an outlet for dispensing a fluid, the device dispensing portion defining a longitudinal axis at an angle with the tank longitudinal axis for dispensing fluid substantially free of centripetal swirling action; and
a compression single point load cell located at the dispensing portion outlet to dispense fluid at a predetermined amount.

According to another embodiment, there is provided a device dispensing portion where the angle is comprised between about 35° and about 85°.

According to another embodiment, there is provided a device dispensing portion where the device dispensing portion material is selected from the group consisting of stainless steel, chrome, nickel and aluminum.

According to another embodiment, there is provided a device for dispensing a fluid of a predetermined amount which comprises: a tank having an inlet for receiving a fluid and an outlet for dispensing a fluid, the tank defining a first longitudinal axis; a device dispensing portion extending from the outlet for receiving a fluid and having an outlet for dispensing a fluid, the device dispensing portion defining a second longitudinal axis at an angle with the first longitudinal axis for dispensing fluid substantially free of centripetal swirling action; and a compression single point load cell located at the device dispensing portion outlet to dispense fluid at a predetermined amount.

According to another embodiment, there is provided a device dispensing portion where the angle is comprised between about 35° and about 85°.

According to another embodiment, there is provided a device where the inlet of the device dispensing portion peripherally extending from the outlet of the sealed tank.

According to another embodiment, there is provided a device where the tank material is selected from the group consisting of stainless steel, chrome, nickel and aluminum.

According to another embodiment, there is provided a system for dispensing more than one fluid which comprises: at least two devices; and a control panel for controlling the amount for dispensing a fluid of a predetermined amount.

According to another embodiment, there is provided in a method for dispensing a fluid from a tank the improvement comprises:
dispensing fluid at an angle relative to a longitudinal axis of the tank for dispensing fluid substantially free of centripetal swirling action.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1A is a view illustrating a device dispensing portion, in accordance with an embodiment.

FIG. 1B is a schematic view illustrating a device dispensing portion, in accordance with an embodiment.

FIG. 2 is a view illustrating a device for dispensing a fluid, in accordance with another embodiment.

FIG. 3 is a view illustrating a system with multiple dispensing devices, in accordance with another embodiment.

FIG. 4 is a schematic front elevation view of a device for dispensing a fluid (5 L tank), in accordance with another embodiment.

FIG. 5 is a schematic front elevation view of a device for dispensing a fluid (50 L tank), in accordance with another embodiment.

FIG. 6 is a schematic front elevation view of a device for dispensing a fluid (100 L tank), in accordance with another embodiment.

FIG. 7 is a schematic front elevation view of a device for dispensing a fluid (150 L tank), in accordance with another embodiment.

FIG. 8 is a schematic front elevation view of a device for dispensing a fluid (200 L tank), in accordance with another embodiment.

It will be noted that throughout the appended drawings, like features are identified by like reference numerals.

### DETAILED DESCRIPTION

In the increasingly specialized process and products demanded by industry today, there is a growing demand for technology that produces highly precise results and focuses on mass production with little or no human interaction.

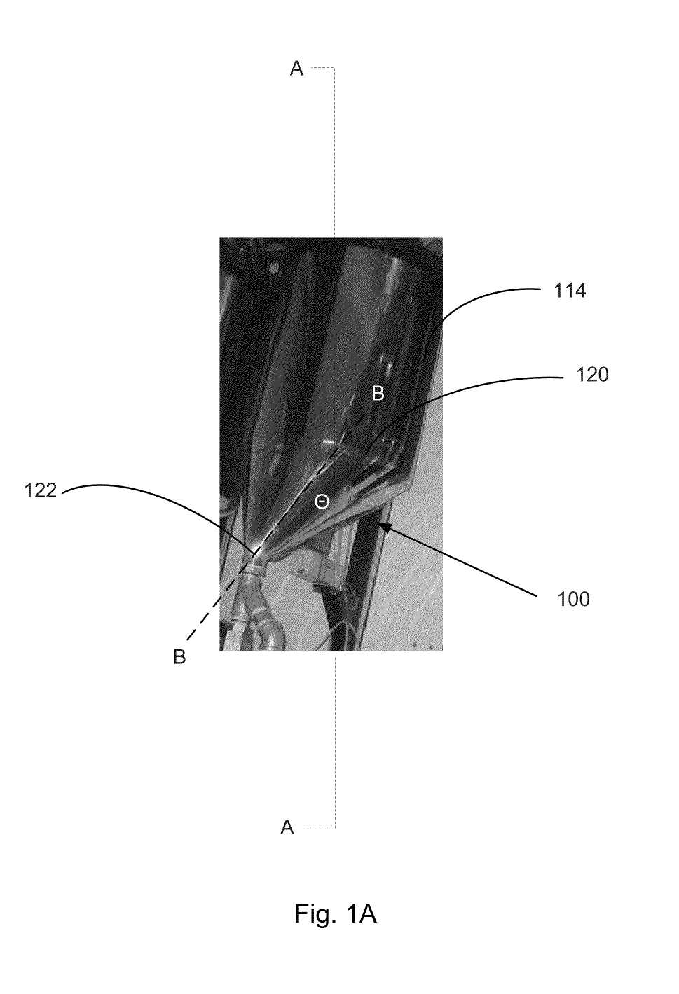

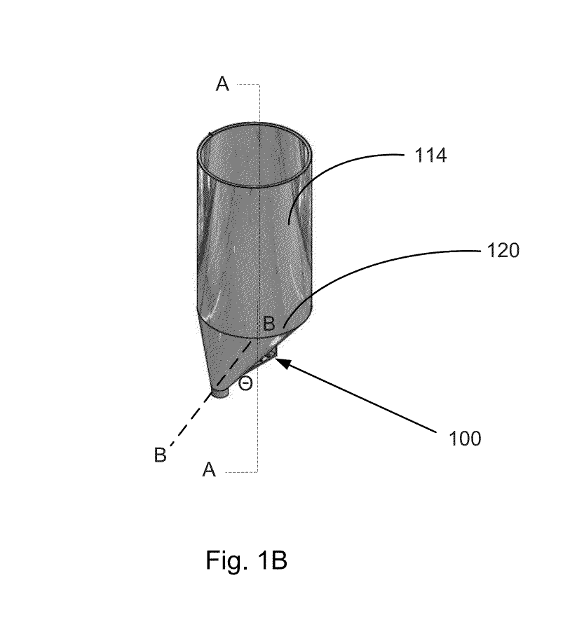

Referring now to the drawings, concurrently referring to FIG. 1A and FIG. 1B, there is shown a device dispensing portion 100, in accordance with an embodiment of the present description. The device dispensing portion 100 is to be installed on a dispensing fluid tank 114 having a longitudinal axis A-A. The device dispensing portion 100 comprises an inlet 120 for receiving a fluid and an outlet 122 for dispensing a fluid. As the dispensing fluid tank defines a longitudinal axis A-A, the device dispensing portion 100 defines a longitudinal axis B-B. An angle Θ is defined between the dispensing fluid axis A-A and the device dispensing portion longitudinal axis B-B allowing the fluid to be dispensed from the device dispensing portion 100 substantially free of centripetal swirling action. It is to be noted that the inferior portion of the dispensing portion is made for decreasing the vortex effects.

Still referring to FIG. 1, the angle Θ which is defined between the dispensing fluid tank longitudinal axis A-A and the device dispensing portion longitudinal axis B-B is comprised between about 35° and about 85°, depending on the fluid to be dispensed. Preferably, the angle Θ which is defined between the dispensing fluid tank longitudinal axis A-A and the device dispensing portion longitudinal axis B-B is comprised between about 45° and about 75°. More preferably, the angle Θ which is defined between the dispensing fluid tank longitudinal axis A-A and the device dispensing portion longitudinal axis B-B is comprised between about 50° and about 60° and more preferably, the angle Θ which is defined between the dispensing fluid tank longitudinal axis A-A and the device dispensing portion longitudinal axis B-B is 53°. Also, it is to be mentioned that, according to this embodiment, the inlet 120 of the device dispensing portion 100 peripherally extends from the dispensing fluid tank 114. However, in another embodiment, the device dispensing portion 100 does not need to extend the complete surface area of the fluid tank 114 for the device dispensing portion to be functional.

The device dispensing portion material can be selected from the group consisting of stainless steel (stainless 304 and 306 by example), chrome, nickel, aluminum and the like.

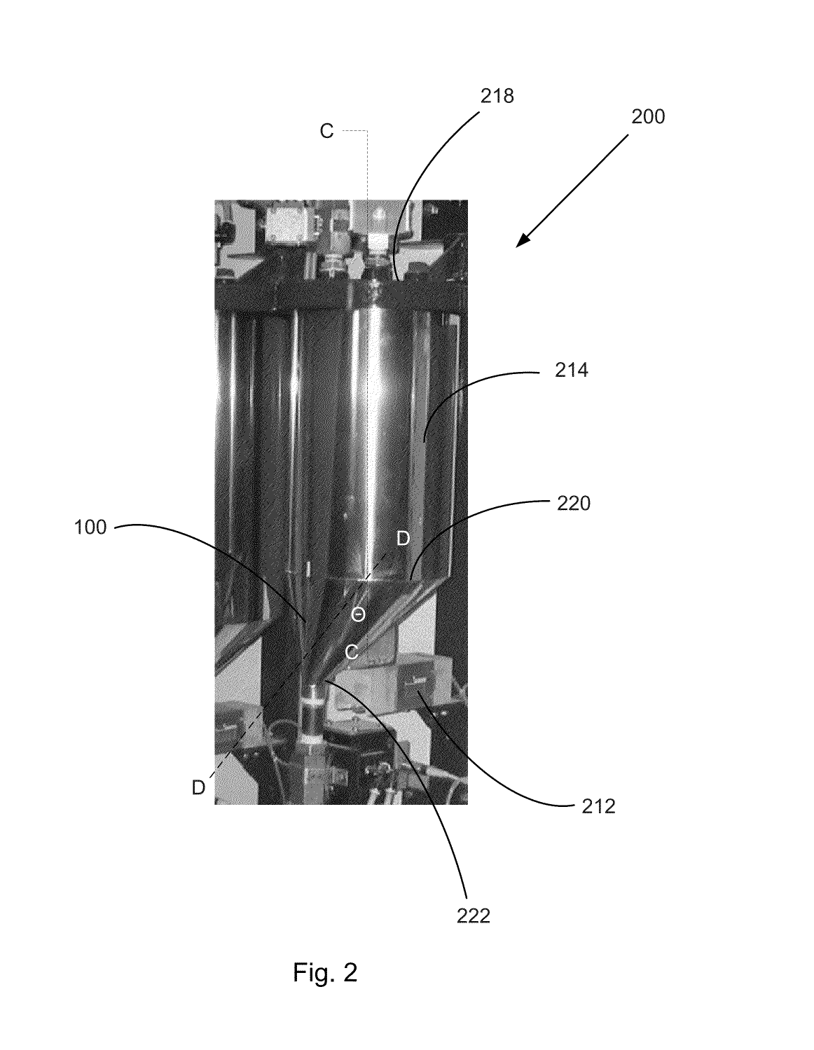

Referring now to FIG. 2, there is shown a dispensing device 200, in accordance with another embodiment. The dispensing device 200, for dispensing a fluid of a predetermined amount, comprises a tank 214 having an inlet 218, for receiving a fluid, and an outlet 220, for dispensing a fluid. The tank 214 defines a first longitudinal axis C-C. The dispensing device 200 comprises a device dispensing portion 100, which extends from the outlet 220 of the tank 214 for receiving a fluid, has an outlet 222 for dispensing a fluid. As in FIG. 1, the device dispensing portion 100 defines a second longitudinal axis D-D at an angle Θ with the first longitudinal axis C-C for dispensing a fluid substantially free of centripetal swirling actions. The dispensing device 200 also comprises a compression single point load cell 212 (precision of about 1 g/1 ml) located at the device dispensing portion outlet 222 to dispense fluid at a predetermined amount.

Still referring to FIG. 2, the angle Θ, which is defined between the dispensing fluid tank longitudinal axis D-D and the device dispensing portion longitudinal axis C-C is comprised between about 35° and about 85° depending on the fluid to be dispensed. More preferably, the angle Θ, which is defined between the dispensing fluid tank longitudinal axis D-D and the device dispensing portion longitudinal axis C-C is comprised between about 45° and about 75° depending on the fluid to be dispensed. More preferably, the angle Θ, which is defined between the dispensing fluid tank longitudinal axis D-D and the device dispensing portion longitudinal axis C-C is comprised between about 50° and about 50° depending on the fluid to be dispensed. More preferably, the angle Θ, which is defined between the dispensing fluid tank longitudinal axis D-D and the device dispensing portion longitudinal axis C-C is 53° depending on the fluid to be dispensed. Also, it is to be mentioned that according to this embodiment, the device dispensing portion 100 peripherally extends from the dispensing fluid tank outlet 214.

Moreover, the device dispensing portion material can be selected from the group consisting of stainless steel, chrome, nickel, aluminum and the like. It is important to be mentioned that the material of device dispensing portion 100 could be the same or different from the material of the tank 214.

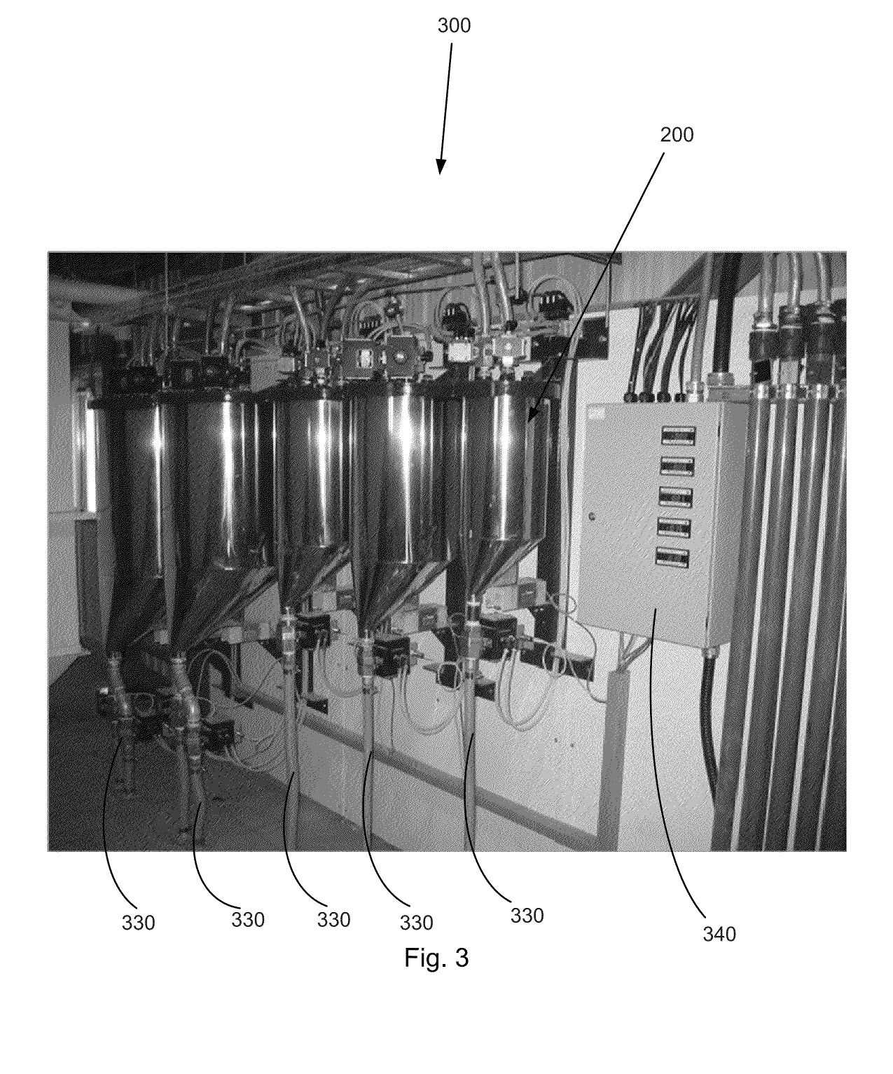

Referring now to FIG. 3, there is shown a dispensing system 300, in accordance with another embodiment. The dispensing system 300, for dispensing more than one fluid, comprises at least two dispensing devices 200, as presented in FIG. 2.

Moreover, the dispensing system 300 comprises connections 330 to mixing and/or dispensing fluids together and/or to move them to a second commune receptacle.

The dispensing system 300 also comprises a control panel 340 for controlling the amount for dispensing a fluid of a predetermined amount and substantially free of centripetal swirling action.

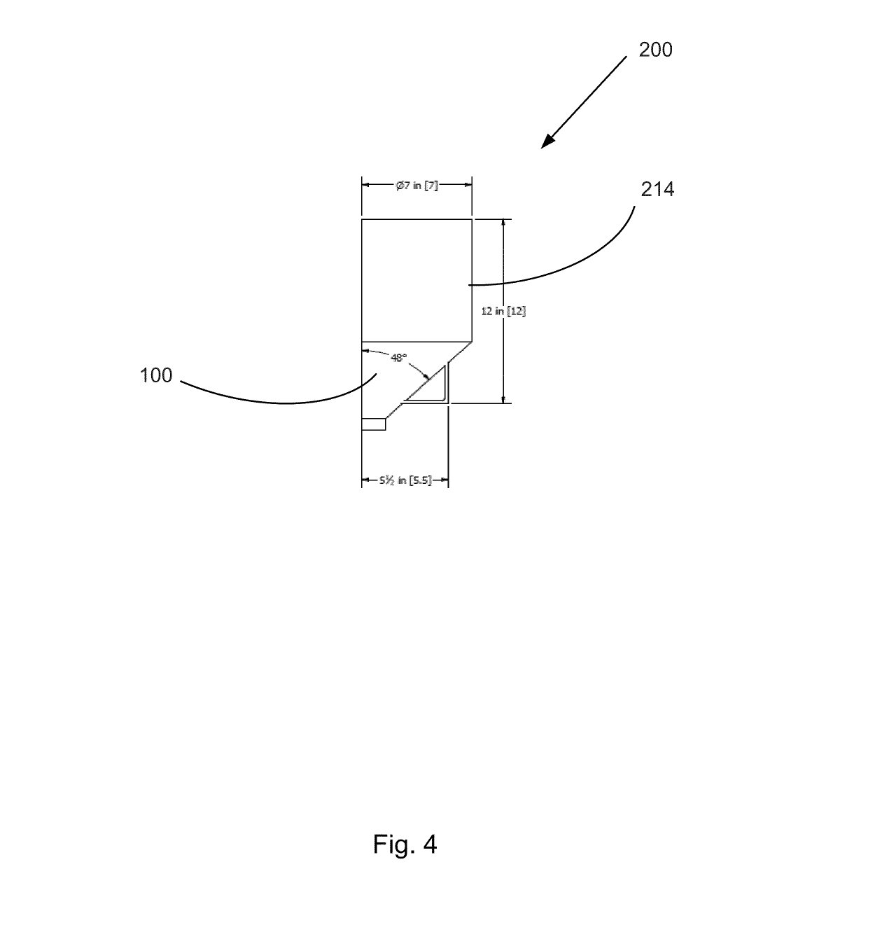

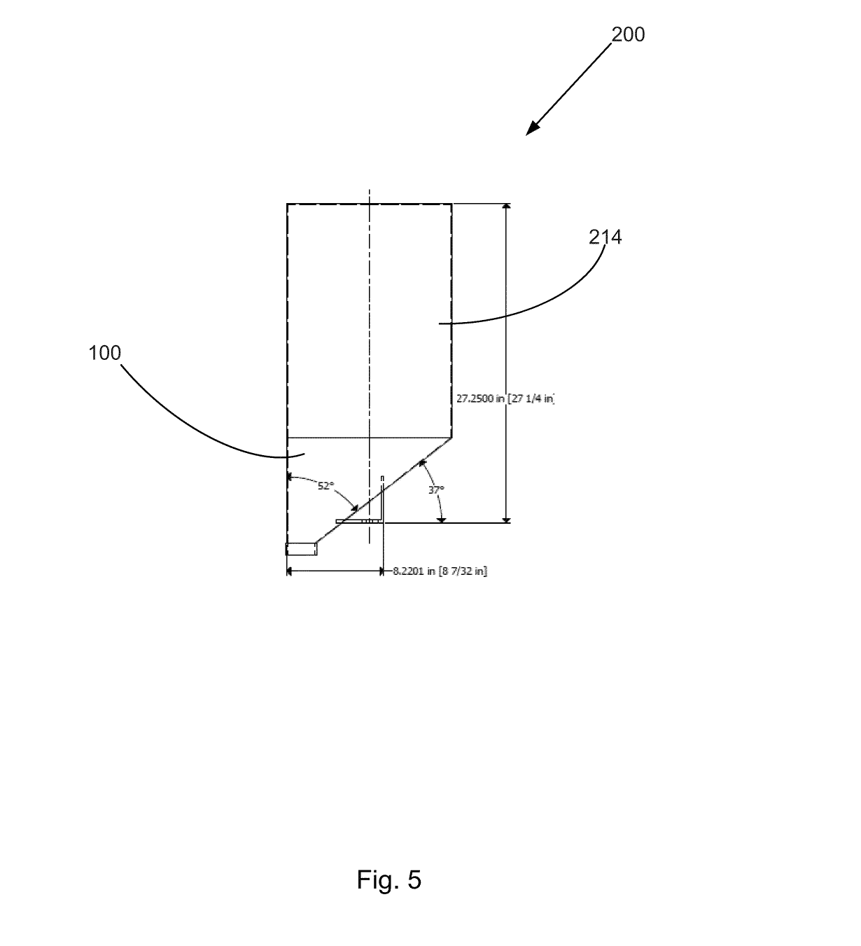

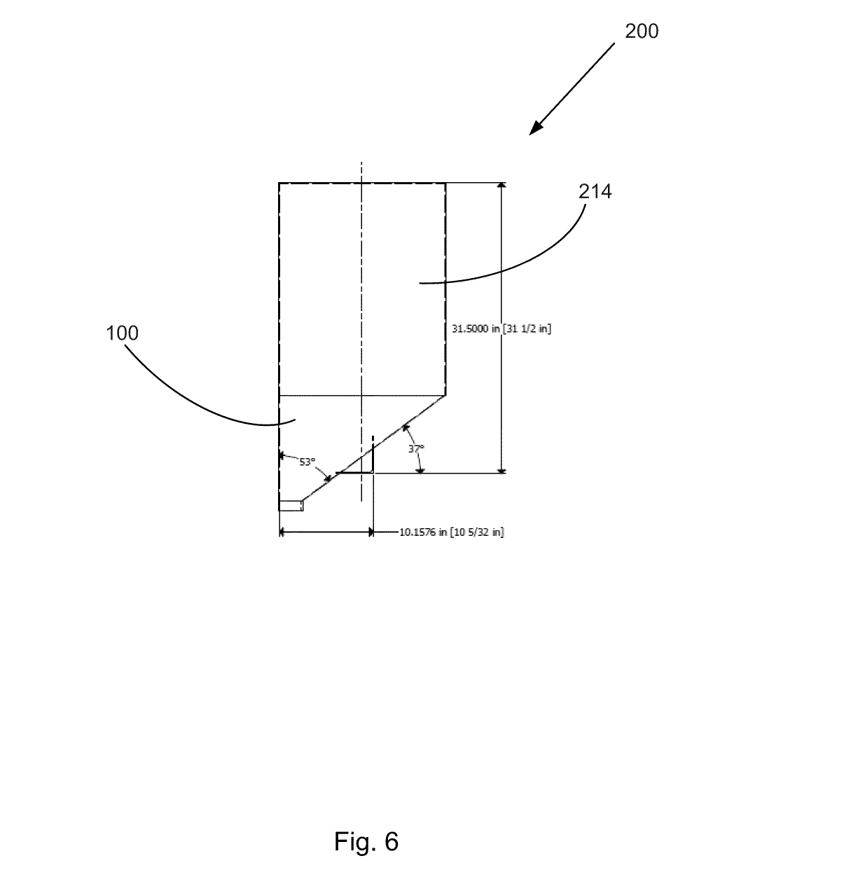

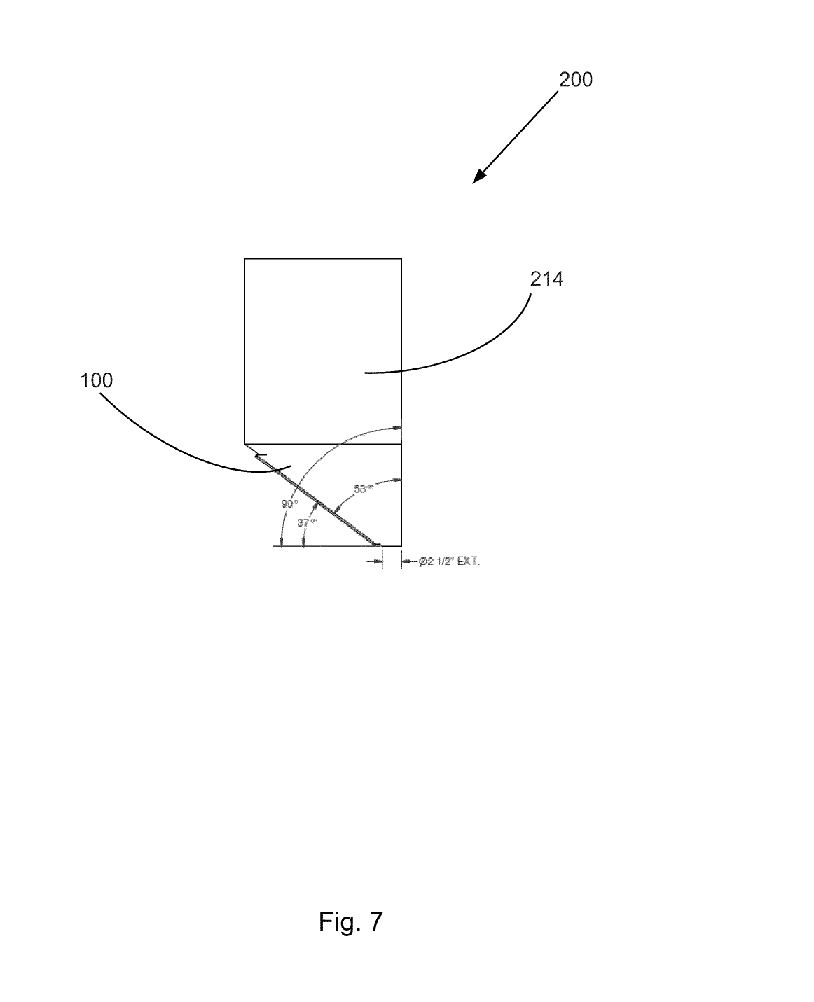

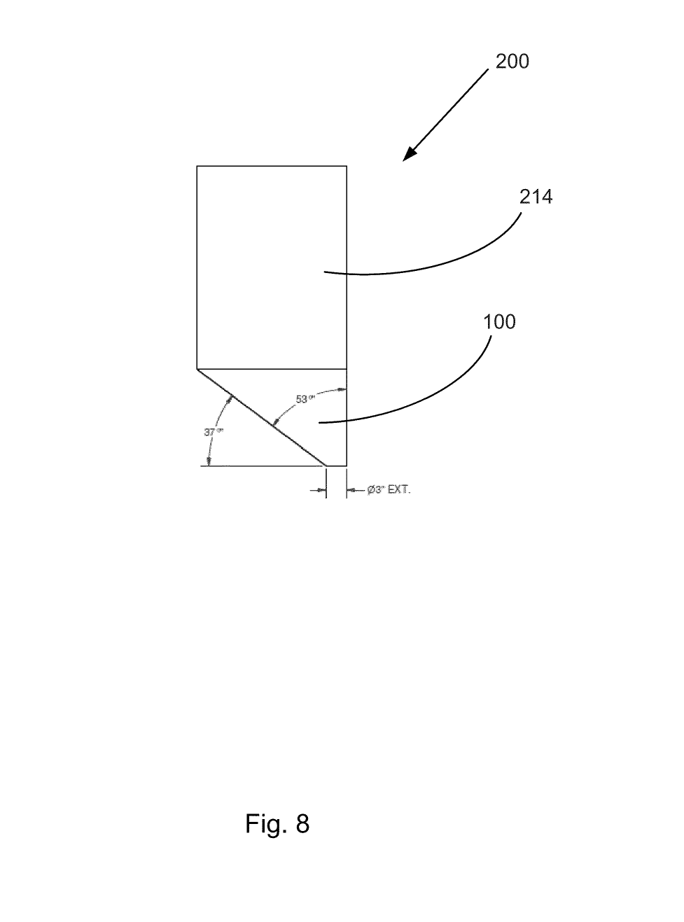

Concurrently referring to FIG. 4 to FIG. 8, there is shown a schematic front elevation view of a device for dispensing a fluid, in accordance with different embodiments. In FIG. 4, the volume of the tank 214 of the dispensing device 200 is 5 L. In FIG. 5, the volume of the tank 214 of the dispensing device 200 is 50 L. In FIG. 6, the volume of the tank 214 of the dispensing device 200 is 100 L. In FIG. 7, the volume of the tank 214 of the dispensing device 200 is 150 L. In FIG. 8, the volume of the tank 214 of the dispensing device 200 is 200 L. Moreover, there exists a relation between the volume of the tank 214 of the dispensing device 200 and the angle Θ. Indeed, a maximal volume of the tank 214 of the dispensing device 200 may require a maximal angle Θ for the device dispensing portion to avoid centripetal swirling action. On the other hand, a minimal volume of the tank 214 of the dispensing device 200 may require a minimal angle Θ for the device dispensing portion to avoid centripetal swirling action.

According to another embodiment, there is described a method for dispensing a fluid substantially free of centripetal swirling action at a certain angle by using a device dispensing portion 100.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A device dispensing portion to be installed on a dispensing fluid tank having an outlet, an inlet and a longitudinal axis which comprises:
an inlet for receiving a fluid and for being connected to said fluid tank outlet;
an outlet for dispensing a fluid, said device dispensing portion defining a longitudinal axis at an angle with said tank longitudinal axis for dispensing fluid substantially free of centripetal swirling action; and
a compression single point load cell located at said dispensing portion outlet to dispense fluid at a predetermined amount.

2. The device dispensing portion of claim 1, wherein said angle is comprised between about 35° and about 85°.

3. The device dispensing portion of claim 1, wherein said inlet of said device dispensing portion peripherally extending from said dispensing fluid tank outlet.

4. The device dispensing portion of claim 1, wherein said device dispensing portion material is selected from the group consisting of stainless steel, chrome, nickel and aluminum.

5. A device for dispensing a fluid of a predetermined amount which comprises:
a tank having an inlet for receiving a fluid and an outlet for dispensing a fluid, said tank defining a first longitudinal axis;
a device dispensing portion extending from said outlet for receiving a fluid and having an outlet for dispensing a fluid, said device dispensing portion defining a second longitudinal axis at an angle with said first longitudinal axis for dispensing fluid substantially free of centripetal swirling action; and
a compression single point load cell located at said device dispensing portion outlet to dispense fluid at a predetermined amount.

6. The device dispensing portion of claim 5, wherein said angle is comprised between about 35° and about 85°.

7. The device of claim 5, wherein said inlet of said device dispensing portion peripherally extending from said outlet of said sealed tank.

8. The device of claim 5, wherein said tank material is selected from the group consisting of stainless steel, chrome, nickel and aluminum.

9. A system for dispensing more than one fluid which comprises:
at least two devices as claimed in claim 5; and
a control panel for controlling the amount for dispensing a fluid of a predetermined amount.

10. In a method for dispensing a fluid from a tank the improvement comprises:
dispensing fluid at an angle relative to a longitudinal axis of said tank for dispensing fluid substantially free of centripetal swirling action.
